(19) United States
(12) Patent Application Publication
(10) Pub. No.: US 2026/0269462 A1
(43) Pub. Date: Sep. 10, 2026

(54) ANTENNA MODULE AND MOTOR VEHICLE

(71) Applicant: Continental Automotive Technologies GmbH, Hannover (DE)

(72) Inventors: Florian Butscher, Aschau im Chiemgau (DE); Rudolf Hildebrand, Holzkirchen (DE)

(73) Assignee: Continental Automotive Technologies GmbH, Hannover (DE)

(21) Appl. No.: 18/876,029

(22) PCT Filed: Jun. 5, 2023
(86) PCT No.: PCT/DE2023/200111

§ 371 Date: Dec. 17, 2024

(30) Foreign Application Priority Data
Jul. 1, 2022 (DE) 10 2022 206 756.8

(51) Int. Cl. H01Q 1/32

(52) U.S. Cl. CPC H01Q 1/3275

(57) ABSTRACT

Disclosed is a motor vehicle and an antenna module, in particular a roof antenna module for a motor vehicle, having at least one sheet-metal antenna for receiving and/or transmitting radio signals, which sheet-metal antenna comprising in each case one or more connecting elements, which are formed in one piece with the sheet-metal antenna, for making contact with a printed circuit board.

### DESCRIPTION

The invention relates to an antenna module and to a motor vehicle.

Antenna modules are known, for example, from DE 10 2005 054 286B4, EP 3 011 636B1, WO 2014/204494 A1, US 2016/0104932 A1 and U.S. Pat. No. 9,793,602 B2.

The object of the present invention is to provide an improved configuration of an antenna module for a motor vehicle. The object is efficiently achieved in each case by the subjects of the independent claims. Some particularly advantageous configurations of the invention are specified in the independent claims.

Further possible features and advantages of configurations of the invention will become apparent from the following description of some preferred configurations of the invention with reference to the drawing, in which:

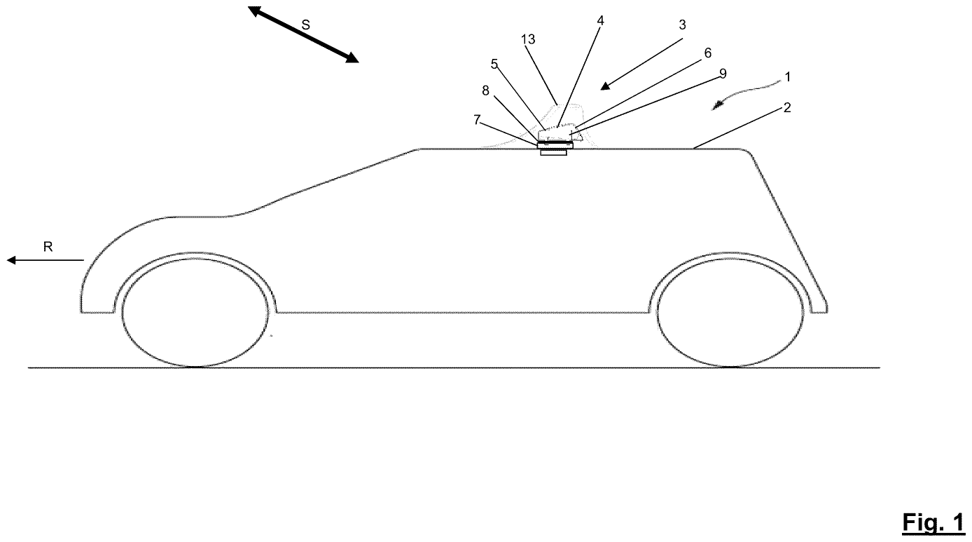

FIG. 1 shows, in longitudinal section in a simplified manner, a motor vehicle having a (roof) antenna module for transmitting and/or receiving radio signals,

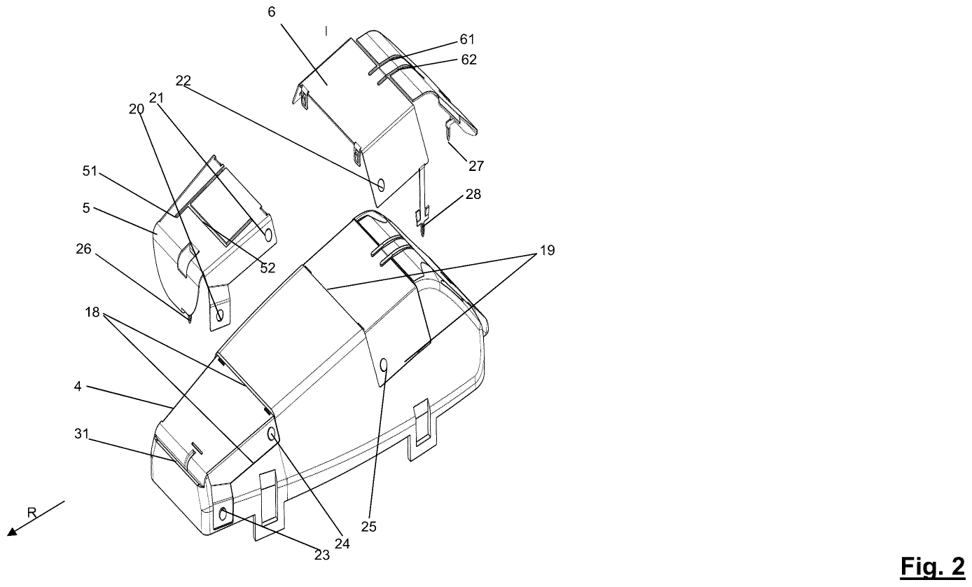

FIG. 2 shows, in a perspective view, a cap (inner radome) of an antenna module, with sheet-metal antennas,

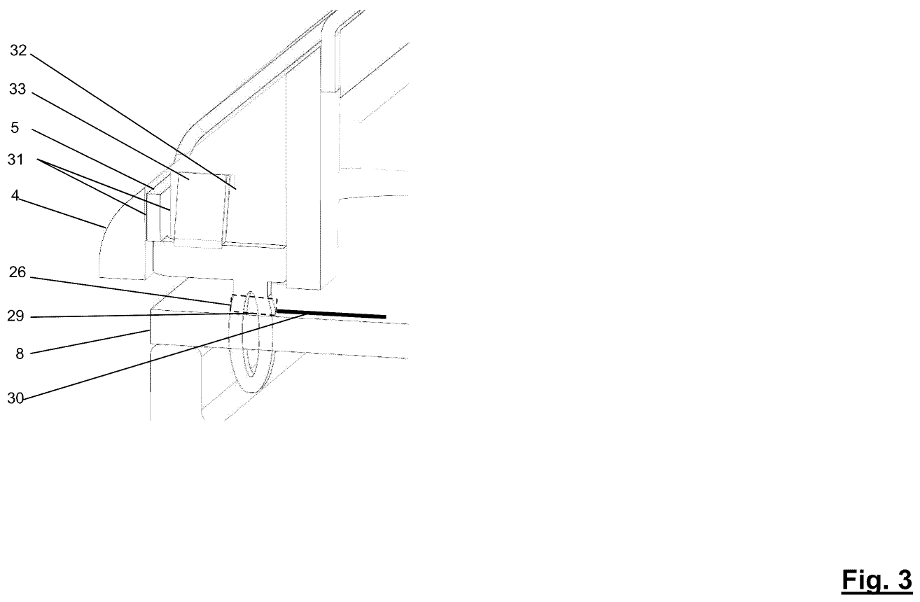

FIG. 3 shows, in a perspective detail view, a press-fit connection, which contacts a printed circuit board and is secured by a tab on the cap,

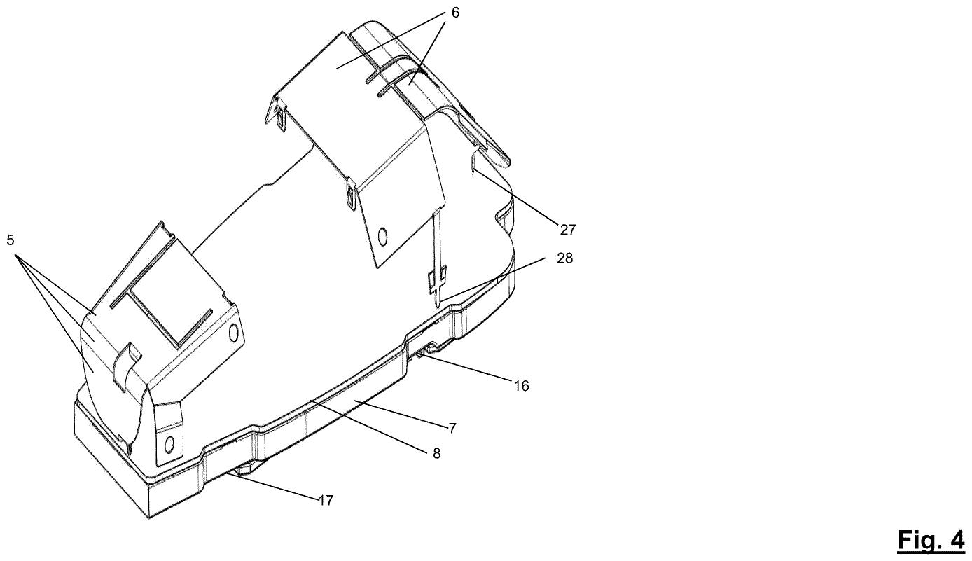

FIG. 4 shows, in a perspective view, a front sheet-metal antenna and rear sheet-metal antenna, and also a chassis,

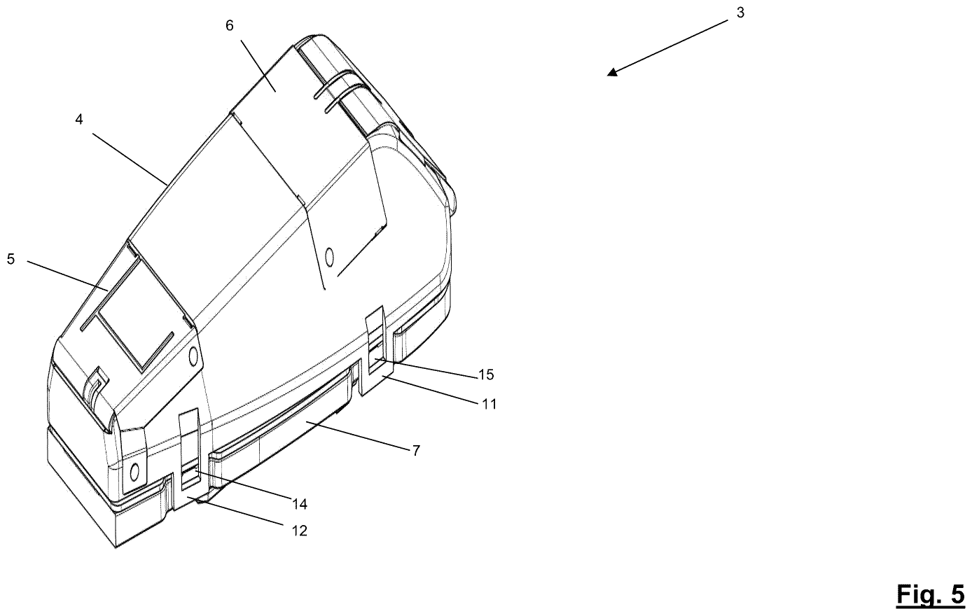

FIG. 5 shows, in a perspective view, an assembled antenna module with sheet-metal antennas,

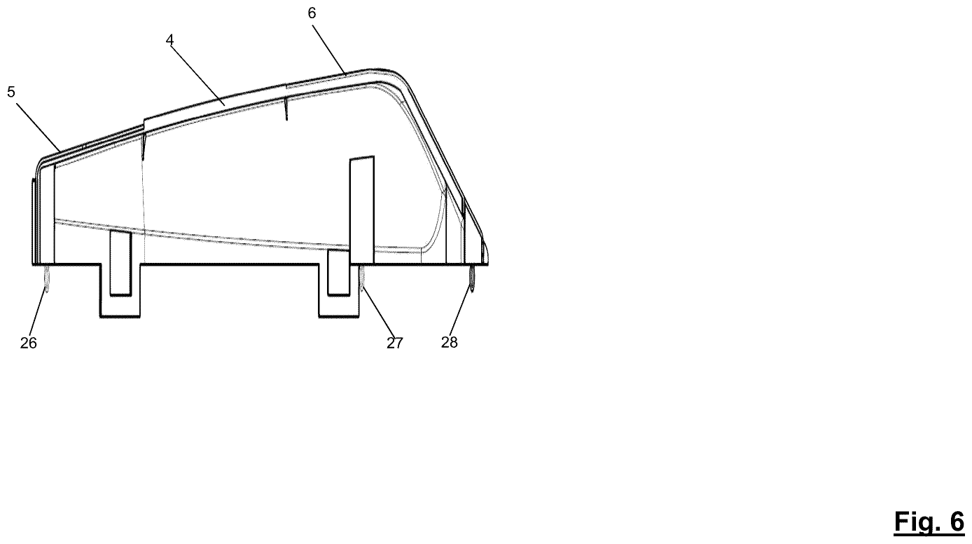

FIG. 6 shows, in a cross section, a cap and sheet-metal antennas with press-fit connections as connecting elements,

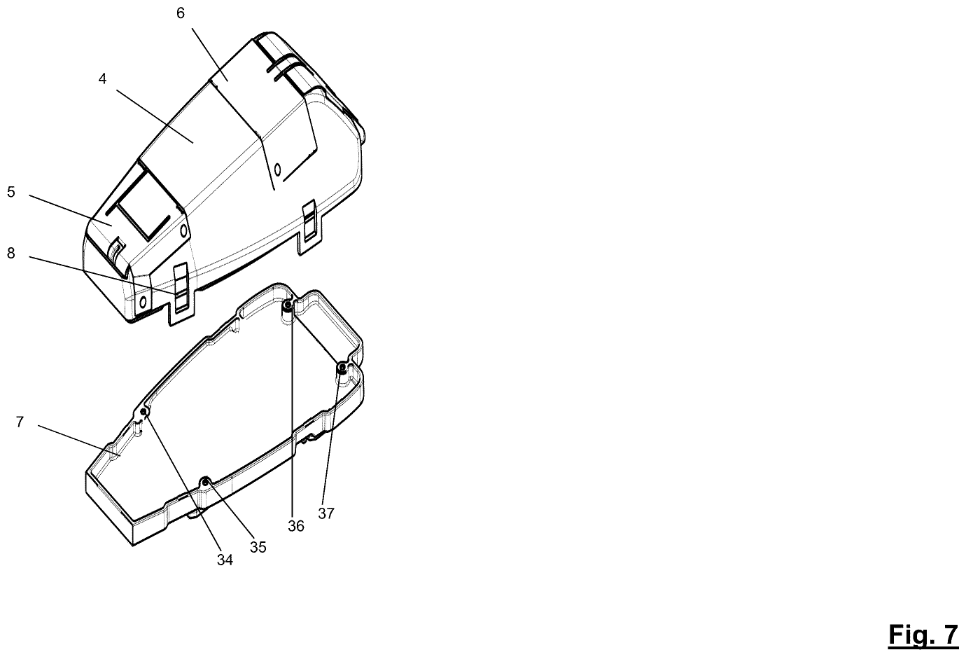

FIG. 7 shows, in a perspective view, a cap with sheet-metal antennas and a printed circuit board,

which is secured on a chassis,

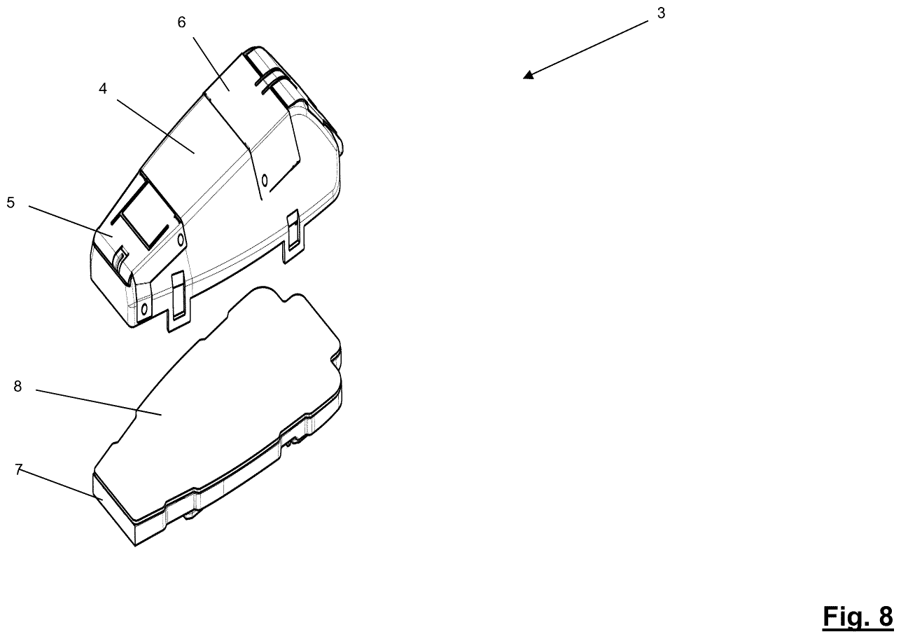

FIG. 8 shows, in a perspective view, a cap with sheet-metal antennas,

which is secured on a chassis with a printed circuit board.

FIG. 1 shows, in longitudinal section by way of example as a configuration of the invention in a simplified manner, a motor vehicle 1 with an antenna module 3 (in the form of a roof antenna module) arranged on the vehicle roof 2 for transmitting and/or receiving signals S, in particular cellular (2G/3G/4G/5G/6G/7G) mobile radio signals S and/or other signals, such as navigation satellite signals, WiFi signals, radio, etc.

The antenna module 3 comprises one or, here, a plurality of, in particular (in the motor vehicle direction) front (5) and rear (6) sheet-metal antennas 5, 6 arranged on a cap 4.

In the state of the antenna module 3 assembled on the vehicle 1, the cap 4 (also referred to as an inner radome), the sheet-metal antennas 5, 6, a chassis 7, and optionally a printed circuit board 8 and/or electronics 9 (such as controllers and/or receivers and/or transmitters and/or amplifiers and/or further (GPS/GNSS etc.) antennas) are located within an outer casing 13 (also referred to as an outer radome) of the antenna module 3.

In the assembled state of the antenna module 3, the outer casing 13 can rest against the roof 2 of the motor vehicle 1 (for example watertightly).

The cap 4 with the sheet-metal antennas 5, 6 can be provided for securing on a chassis 7 comprising a printed circuit board 8, or the cap 4 with the sheet-metal antennas 5, 6 and a printed circuit board 8 can be provided for securing on the chassis 7, in particular with snap-action hooks of the cap 4 for engagement with the chassis 7 and/or the printed circuit board.

FIG. 2 shows, in a perspective view by way of example for one configuration of the invention, a front sheet-metal antenna 5 and a rear sheet-metal antenna 6, which are to be assembled on a cap 4 shown beneath.

The front sheet-metal antenna 5 and a rear sheet-metal antenna 6 can comprise, for example, slots 51, 52, 61, 62, which can form the antenna structure.

To simplify the assembly and for a secure fit, the cap 4 here has indentations 18, 19 (here, for example, recessed contours arranged peripherally at the edge) for embedding (at the surface, for example in a planar manner) in each case one sheet-metal antenna 5 or 6.

For an improved retention of the sheet-metal antennas 5, 6 on the cap 4, recesses (for example bores) 20, 21, 22 are also provided here on the sheet-metal antennas 5, 6, in which elevations or nubs or domes 23, 24, 25 of the cap 4 can engage (or analogously vice versa).

The front sheet-metal antenna 5 comprises one or more connecting elements 26, formed in one piece with the sheet-metal antenna 5 (for example integrated with the antenna structure of the sheet-metal antenna) for contacting (contacts on/in) a printed circuit board 8.

The rear sheet-metal antenna 5 also comprises one or, here, more connecting elements 27, 28 formed in one piece with the sheet-metal antenna 5 for contacting (electrical contacts or tracks on or in) a printed circuit board 8.

The connecting elements 26, 27, 28 can be, in particular, in each case press-fit connections 26, 27, 28, which can be secured to the printed circuit board and/or to the sheet-metal antennas 5, 6 by press-fit,

or can be formed in one piece with sheet-metal antennas 5, 6 for example by cutting and bending a metal sheet.

The press-fit connections 26, 27, 28 can also be inserted for example into recesses or slots in the printed circuit board 8 or can rest against (for example indentations in) the printed circuit board and at that point can contact contacts of the printed circuit board or (contact) elements thereon (and via these the electronics), for example by soldering.

FIG. 3 shows, as a detail in a simplified manner, a press-fit connection 26, which is inserted for example in a recess or indentation, shown by dashed lines, in the printed circuit board 8 (and for example is glued or soldered thereto) and contacts, at that point, contacts and/or a conductor track 30 of the printed circuit board 8 (and via these the electronics).

FIG. 3 further shows a pocket 31, which receives a portion of the sheet-metal antenna 5 during the assembly of the sheet-metal antenna 5 on the cap 4, for example for vibration-proof attachment.

FIG. 3 additionally shows a locking recess (pocket) 32 in the cap 4, in which a locking tab 33 (of the connecting element) of the sheet-metal antenna 5 engages, for example for vibration-proof attachment (of the sheet-metal antenna, in particular of the connecting element 26).

A connecting element 26 (in particular in the form of a press-fit connection) of the sheet-metal antenna 5 (analogously to the sheet-metal antenna 6) is in each case arranged expediently directly next to pockets and/or the (in particular, in the state assembled on a motor vehicle, vertical) part of a sheet-metal antenna guided in a slot, in particular in order to avoid the connecting element 26 or a locking tab becoming a jammer of the actual antenna structure (of 5 or 6) or detuning it too much.

FIG. 4 shows (for illustration without the cap 4) the curved front sheet-metal antenna 5 and the curved rear sheet-metal antenna 6 and also the chassis 7 with a printed circuit board 8.

FIG. 5 shows, in a perspective view and by way of example for one configuration of the invention, an antenna module 3 assembled with a chassis 7 (again without outer casing over it and without vehicle roof below it) with front sheet-metal antenna 5 arranged on the cap 4 and rear sheet-metal antenna 6 and also at least one snap-action hook arrangement 11, 12, for example with recesses for engaging snap-action hooks (of a chassis) and/or snap-action hooks (not shown in greater detail), which engage in edges (visible in FIG. 3) or recesses 16, 17 on the chassis 3.

FIG. 6 shows, in a supplementary manner in cross section, a cap 4 and sheet-metal antennas 5, 6 with connecting elements 26, 27, 28 (in particular press-fit connections).

The cap 4 of the antenna module 3 in FIG. 7 comprises a front sheet-metal antenna 5 arranged on the cap 4 and a rear sheet-metal antenna 6 arranged on the cap 4 and optionally a printed circuit board 8, and is secured with this on the chassis 7.

By screwing (for example in screw domes 34-37) etc., the antenna module 3 can be secured to the roof 2 of a motor vehicle 1 and/or the chassis 7 can be secured to the cap 4.

The cap 4 of the antenna module 3 in FIG. 8 comprises a front sheet-metal antenna 5 arranged on the cap 4 and a rear sheet-metal antenna 6 arranged on the cap 4 and is secured with these on the chassis 7, which comprises a printed circuit board 8.

### LIST OF REFERENCE SIGNS

1 motor vehicle
2 roof
3 antenna module
4 cap
5 front sheet-metal antenna
6 rear sheet-metal antenna
7 chassis
8 printed circuit board
9 electronics
10 outer casing
11 snap-action hook arrangement
12 snap-action hook arrangement
13 outer casing
14 recess
15 recess
16 recess
17 recess
18 contour
19 contour
20 recess
21 recess
22 recess
23 dome
24 dome
25 dome
26 connecting element, in particular press-fit connection
27 connecting element, in particular press-fit connection
28 connecting element, in particular press-fit connection
32 locking recess
33 locking tab
34 screw dome
35 screw dome
36 screw dome
37 screw dome
S signals
R direction of travel

1. An antenna module, comprising:
at least one sheet-metal antenna for receiving and/or transmitting radio signals,
wherein the sheet-metal antenna comprises at least one connecting element, which is formed in one piece with the sheet-metal antenna, configured to make direct contact with a printed circuit board.

2. The antenna module as claimed in claim 1, wherein
the sheet-metal antenna is a bent sheet-metal antenna.

3. The antenna module as claimed in claim 1, wherein
the at least one connecting element of a sheet-metal antenna is a press-fit connection.

4. The antenna module as claimed in claim 1, wherein
the sheet-metal antenna has a plurality of connecting elements, which are formed in one piece with the sheet-metal antenna, and are configured to make contact with a printed circuit board.

5. The antenna module as claimed in claim 1, wherein
the antenna module comprises at least two sheet-metal cellular mobile communication antennas.

6. The antenna module as claimed in claim 1, wherein
the antenna module has a cap supporting the sheet-metal antennas.

7. The antenna module as claimed in claim 6, wherein
the at least one sheet-metal antenna comprises at least one recess bore configured to engage one elevation of the cap.

8. The antenna module as claimed in claim 6, wherein
the cap has at least one slot for guiding a portion of a sheet-metal antenna.

9. The antenna module as claimed in claim 6, wherein
the cap has one or more pockets, into which one locking tab of the sheet-metal antenna is introducible.

10. The antenna module as claimed in claim 1, wherein
a press-fit connection of a sheet-metal antenna is arranged directly next to a pocket,
and/or directly next to a vertical part of the sheet-metal antenna guided in a slot.

11. The antenna module as claimed in claim 6, wherein
the cap is formed with the sheet-metal antennas for securing on a chassis comprising a printed circuit board.

12. The antenna module as claimed in claim 6, wherein
the cap is formed with the sheet-metal antennas configured to secure on a printed circuit board, and is configured to secure on a chassis.

13. The antenna module as claimed in claim 6, wherein
when assembled, there is disposed within the cap at least one of a printed circuit board, a further antenna, electronics, amplifiers and a controller.

14. The antenna module as claimed in claim 6, wherein
the antenna module has an outer casing,
within which, when the antenna module is assembled, there are disposed the cap and sheet-metal antennas,
and which, when the antenna module is assembled, is adjacent to a roof of a motor vehicle.

15. A motor vehicle comprising the antenna module as claimed in claim 1.

16. The antenna module as claimed in claim 1 wherein the antenna module is a roof antenna module for a motor vehicle.

17. The antenna module as claimed in claim 6, wherein the cap has an indentation or recessed contour configured to be embedded in in each case one sheet-metal antenna.

18. The antenna module as claimed in claim 7, wherein the engaging at least one of centers and protects from rattling.

19. The antenna module as claimed in claim 11, wherein the securing on the chassis is with snap-action hooks configured to engage the cap with the chassis and/or the printed circuit board.

20. The antenna module as claimed in claim 12, wherein securing on the chassis is with snap-action hooks configured to engage the cap with the chassis.
